(19) United States
(12) Patent Application Publication
(10) Pub. No.: US 2003/0226493 A1
(43) Pub. Date: Dec. 11, 2003

(54) Signaling apparatus for trailers

(76) Inventor: Gerald E. Williams, Chouteau, OK (US)

Correspondence Address: Frank L. Hart, Attorney at Law, 8911 S. 73rd East ave., Tulsa, OK, 74133, US

(21) Appl. No.: 10/164,346

(22) Filed: Jun. 7, 2002

(51) Int. Cl. B60Q 11/00

(52) U.S. Cl. 116/28 R; 33/264

(57) ABSTRACT

A signaling apparatus has a signaling element connected to one end of a metal column and a magnet connected to the opposite end of the column. The metal column is of sufficient stiffness to support the weight of the signaling element and maintain the element above the magnet when the magnet is attached to an object. The signaling element assists an individual in estimating distances of object relative to said signaling element.

### TECHNICAL FIELD

The subject invention relates to a signaling apparatus for indicating a specific location of an object.

More particularly, the subject invention relates to a signaling apparatus for use on a trailer to indicate a specific location on the trailer relative to adjacent objects.

The use of trailers often present a most frustrating problem for drivers who are not greatly experienced in backing the trailer, hooking up the trailer, and maneuvering the trailer. This is caused by the drivers inability to correctly estimate the distance from a specific location on the trailer and another object. Because of this inability, trailers and articles being moved by the trailer are often damaged and ruined by impact with an object such as a wall of a boat ramp, a tree, or other object.

Many drivers also experience sometimes great difficulty in maneuvering their vehicle to a correct location for hooking the vehicle's trailer hitch to a trailer. This is not only caused by being inaccurate in judging distances, but also in the inability of a driver to see the parts to be connected.

Some devices have been developed which are primarily utilized for other purposes, such as centering a floating boat over a submerged trailer. These devices are generally formed of heavy weight tubing or columns, are expensive, use a great deal of natural resources to manufacture and cost a large amount of money.

The subject invention is directed to overcome one or more of the problems, as set forth above.

### DISCLOSURE OF THE INVENTION

In one aspect of the invention, a signaling apparatus comprises a metal column, a magnet and a signaling element. The metal column has first and second end portions, a diameter smaller than about ⅛ inch, and a length greater than about 2 feet. The magnet is connected to the first end portion of the metal column and the signaling element is connected to the second end portion of the metal column. The metal column is formed with a stiffness sufficient for maintaining the signaling element vertically positioned relative to the first end portion of the metal column in the absence of forces other than gravity exerted on said signaling apparatus.

In another aspect of the invention, a signaling apparatus comprises a magnet, a concave housing, a signaling element and a metal column. The magnet has generally planer first and second face surfaces and an edge and is of general ring configuration. A concave housing is connected to the magnet and cover the first face surface of the magnet and the edge of the magnet. The signaling element has generally planer first and second face surfaces. The metal column has first and second end portions, a diameter smaller than about ⅛ inch and a length greater than about 2 feet. The first end portion of the metal column is connected to he magnet via the concave housing and the second end portion of the metal column is connected to the signaling element. The first face surfaces of the magnet and the signaling element are oriented on the metal column in generally a first direction.

In yet another aspect of the invention, a signaling apparatus comprises a magnet, a concave housing, a signaling element and a metal column. The magnet has generally planer first and second face surfaces and an edge and is of general ring configuration. A concave housing is connected to the magnet with an adhesive and covers the first face surface of the magnet and the edge of the magnet. The signaling element has generally planer first and second face surfaces. The second face surface of the signaling element being light reflective and formed of organic plastic. The metal column has first and second end portions, a diameter of about 1/16 inch and a length of about 2½ feet. The first end portion of the metal column is connected to he magnet via the concave housing and the second end portion of the metal column is connected to the signaling element. The first face surfaces of the magnet and the signaling element are oriented on the metal column in generally a first direction.

### BRIEF DESCRIPTION OF THE DRAWINGS

FIG. 1 is a diagrammatic perspective view of a portion of a trailer with the apparatus of this invention installed thereon;

FIG. 2 is a diagrammatic side view of the signaling element of the apparatus of this invention including a second magnet;

FIG. 3 is a diagrammatic view of another type signaling element;

FIG. 4 is a diagrammatic view of yet another type signaling element; and

FIG. 5 is a frontal view of the loop of the column which is used for connecting the second magnet to the column.

### BEST MODE FOR CARRYING OUT THE INVENTION

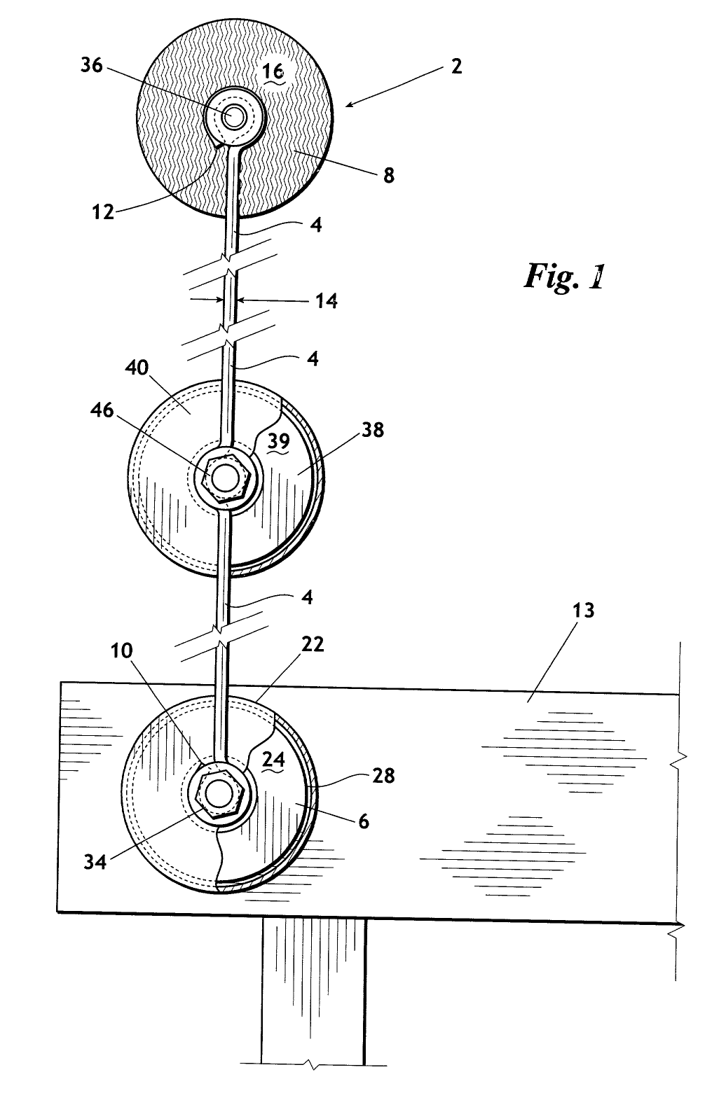

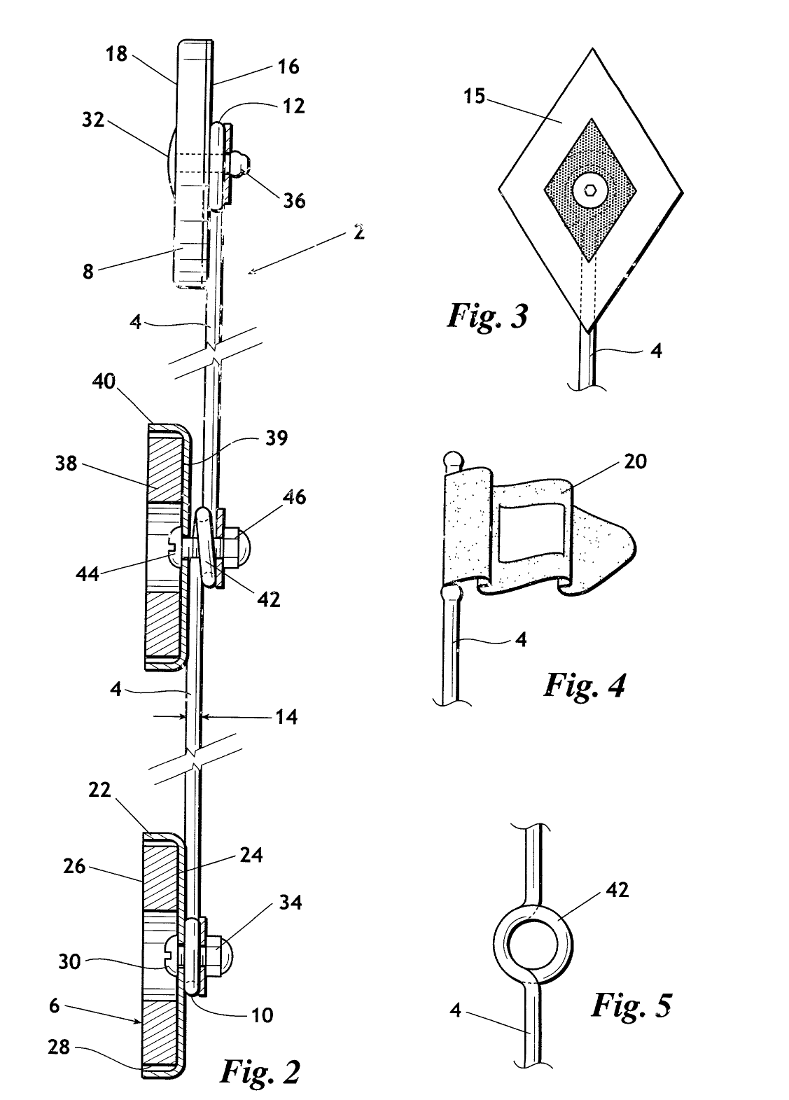

Referring to FIGS. 1 and 2, the signaling apparatus 2 of this invention has a wire or metal column 4, a magnet 6, and a signaling element 8. The metal column 4 has first and second end portions 10,12, (see FIG. 2) a diameter 14 smaller than about ⅛ inch, preferably about 1/16 inch, and a length greater than about 2 feet, preferably about 2½

feet. The metal column 4 is formed with a stiffness sufficient for maintaining the hereafter described signaling element 8, above and generally, vertically positioned relative to the first end portion 10 of the metal column in the absence of forces other than gravity exerted on said signaling apparatus 2 and in the installed position of the signaling apparatus 2 on a trailer 13, for example.

Referring to FIG. 2, the magnet 6 is connected to the first end portion 10 of the metal column 4. The signal element 8 is connected at the second end portion 12 of the metal column 4.

The signaling element 8 can be one of an attention getting object, such as a metal element 15 (FIG. 3) of various configurations, such as round, triangular, oval, or other configuration, each having first and second generally planer face surfaces 16,18, or a flag 20 (See FIG. 4), or more preferably a light reflecting device (FIGS. 1 and 2) formed of organic plastic.

In the preferred embodiment, as shown in FIGS. 1,2, the apparatus of this invention has a concave housing 22 and the magnet 6 is of a ring configuration having first and second generally planer face surfaces 24,26 and an edge 28. The magnet 6 is positioned within the concave surface of the housing 22 with the housing 22 covering the first face surface 24 and edge 28 of the magnet 6. The magnet 6 is connected to the housing 22, preferably by an adhesive, such as and the housing 22 is connected to the first end portion 10 of the metal column 4.

In the preferred embodiment of this invention, the first and second end portions 10,12 of the metal column 4 are bent to partially encircle a respective bolt 30,32. The bolts 30,32 each pass through a respective magnet housing 22 and signaling element 8 and fixedly sandwich the respective end portion 10,12 of the metal column 4 between the respective magnet 6 and signal element 8 and an associated nut 34,36 which is screw threadably connected to its associated bolt 30,32.

In another embodiment of this invention, as shown in FIG. 2, the apparatus 2 includes a second magnet 38 having a housing 40. The second magnet 38 and associated housing 40 are of similar construction as the first and are connected one to the other and to the column 4 as set forth with regard to the embodiment of FIG. 1.

However, in this embodiment of FIG. 2, the second magnet housing 40 is preferably connected to the metal column 4 at a location at which the distance from the second magnet 38 to the second end portion 12 of the column 4 is less than the distance from said second magnet 38 to said column first end portion 10. Preferably the second magnet 38 is positioned immediately adjacent the signaling element 8 in the installed position on the metal column 4. Also, it is preferred that the first face 16 of the signaling element 8 and first faces 24, 39 of the magnets 6,38 be oriented in the same direction, as later more fully described.

Referring to FIG. 5, the second magnet housing 40 is preferably connected to the housing by a bolt 44 and nut 46, as set forth above with a loop 42 of the metal column 4 sandwiched as set forth above. However, it should be understood that the signaling element 8, magnets 6,38, and magnet housings 22,40 can be connected one to the other and to the metal column 4 by other fastening means, such as welding, for example, without departing from this invention.

The apparatus of this invention is well adapted to be positioned on trailers in order to assist drivers to more correctly estimate distances. In the preferred embodiment with the signaling element 8 and magnet 6 oriented in the same general direction, the magnet can be removeably attached to an upright portion on the back of the trailer and the signaling element visability by an operator will be enhanced. This orientation also assists in storage on the trailer when a second magnet 38 is used and the apparatus is positioned generally horizontally with the magnets 6,38 contacting the trailer frame and maintaining the apparatus 2 with the trailer.

It should be understood that if the apparatus 2 cannot be mounted on an upright portion on the rear of the trailer, the column 4 can be twisted 90 degrees and provide a similar view as said preferred orientation of the apparatus 2 attached to the back of the trailer. It will be readily apparent that the column can also be twisted and bent to accommodate other instillation problems.

It is preferred that the column have a length greater than 2 feet. If less than this distance, it becomes difficult for an operator to see the signaling element from his position in the towing vehicle. It has been found that about 2½ distance covers most trailer constructions and that greater than about 3 fee will represent a waste of materials, labor, and natural resources.

Other aspects, objects and advantages of this invention can be obtained from a study of the drawings, the disclosure, and the appended claims.

What is claimed is:

1. A signaling apparatus, comprising:
a metal column having first and second end portions, a diameter smaller than about ⅛ inch, and a length greater than about 2 feet;
a magnet connected to the first end portion of the metal column; and
a signaling element connected at the second end portion of the metal column, said metal column being formed with a stiffness sufficient for maintaining the signaling element above and vertically positioned relative to the first end portion of the metal column in the absence of forces other than gravity exerted on said signaling apparatus.

2. A signaling apparatus, as set forth in claim 1, wherein the signaling element is one of a light reflecting device, an attention initiating device, and a flag.

3. A signaling apparatus, as set forth in claim 1, wherein the magnet is of ring configuration having opposed first and second faces and an edge.

4. A signaling apparatus, as set forth in claim 3, including a concave housing covering the first face and the edge of the magnet, said magnet being fixedly connected to the housing and said housing being fixedly connected to the first end portion of the metal column.

5. A signaling apparatus, as set forth in claim 4, including first and second bolts and respective nuts and wherein each first and second end portions of the metal column extends about at least a portion of a respective bolt, said first bolt and respective nut connecting the concave housing and associated magnet to the metal column first end portion and said second bolt and respective nut connecting the signaling element to the metal column second end portion.

6. A signaling apparatus, as set forth in claim 4, wherein the magnet is connected to the housing by an adhesive.

7. A signaling apparatus, as set forth in claim 1, including a second magnet connected to the metal column at a location spaced from said metal column first end portion.

8. A signaling apparatus, as set forth in claim 7, wherein the second magnet is connected to the metal column at a location on said metal column at which the distance from said second magnet to said second end portion is less than the distance from said second magnet to said first location.

9. A signaling apparatus, as set forth in claim 8, wherein the second magnet is immediately adjacent the signaling element.

10. A signaling element, as set forth in claim 1, wherein the signaling element is formed of organic plastic.

11. A signaling apparatus, as set forth in claim 1, wherein the signaling element and the magnet have a planar first face surface and said signaling element and magnet are connected to the metal column with said first face surfaces facing in generally the same direction.

12. A signaling apparatus, as set forth in claim 11, including a second magnet having a first face surface and being connected to the metal column, said first and second magnets and said signaling element being connected to the metal column with their first face surfaces facing in generally the same direction.

13. A signaling apparatus, comprising:
a magnet having generally planer first and second face surfaces and an edge and being of general ring configuration;
a concave housing covering the first face surface and edge of the magnet, said magnet being fixedly connected to the housing;
a signaling element having generally planer first and second face surfaces; and
a metal column having first and second end portions, a diameter smaller than about ⅛ inch and a length greater than about 2 feet, said first end portion of the metal column being connected to the magnet via the concave housing and said second end portion of the metal column being connected to the signaling element, said first face surfaces of the magnet and signaling element being oriented on the metal column in generally a first direction.

14. A signaling apparatus, comprising:
a magnet having generally planer first and second face surfaces and an edge and being of general ring configuration;
a concave housing covering the first face surface and edge of the magnet, said magnet being fixedly connected to the housing with an adhesive;
a signaling element having generally planer first and second face surfaces, said second surface being light reflective and formed of organic plastic; and
a metal column having first and second end portions, a diameter smaller than about ⅛ inch and a length greater than about 2 feet, said first end portion of the metal column being connected to the magnet via the concave housing and said second end portion of the metal column being connected to the signaling element, said first face surfaces of the magnet and signaling element being oriented on the metal column in generally a first direction.
